(19) United States
(12) Patent Application Publication
(10) Pub. No.: US 2025/0379611 A1
(43) Pub. Date: Dec. 11, 2025

(54) THREE-DIMENSIONAL TONE HOPPING SIGNAL ACQUISITION

(71) Applicant: BAE Systems Information and Electronic Systems Integration Inc., Nashua, NH (US)

(72) Inventors: Michael N. Kloos, Atkins, IA (US); Mitchell Dennis, Cedar Rapids, IA (US)

(73) Assignee: BAE Systems Information and Electronic Systems Integration Inc., Nashua, NH (US)

(21) Appl. No.: 19/232,131

(22) Filed: Jun. 9, 2025

Related U.S. Application Data
(60) Provisional application No. 63/658,257, filed on Jun. 10, 2024.

(51) Int. Cl. H04B 1/7156; H04B 1/715

(52) U.S. Cl. CPC H04B 1/7156; H04B 1/715; H04B 2001/7152; H04B 2001/71563

(57) ABSTRACT

A signal acquisition device includes a signal channelizer module and a signal processing module. The signal channelizer module is configured to channelize an incoming signal from a moving platform into a first plurality of channels across a first range of frequencies to produce a first channelized signal, to channelize the first channelized signal into a second plurality of channels across a second range of frequencies to produce a second channelized signal, and to store the second channelized signal into a memory. The signal processing module is configured to retrieve the second channelized signal from the memory and search the second channelized signal for a signal of interest.

### CROSS-REFERENCE TO RELATED APPLICATIONS

This application claims the benefit of U.S. Provisional Patent Application No. 63/658,257, filed on Jun. 10, 2024.

### FIELD OF DISCLOSURE

The present disclosure relates to signal processing techniques, and more particularly, to techniques for three-dimensional tone hopping signal acquisition.

### BACKGROUND

Satellite-based radio navigation systems include a constellation of satellites in Earth orbit that transmit signals to a receiver on Earth. The receiver first acquires the signals from multiple satellites (typically three or more) in different orbital positions, and then computes its geographical position based on information obtained from the signals. Due to propagation delays, Doppler effects, and noise, there are non-trivial issues relating to the acquisition of these signals.

### BRIEF DESCRIPTION OF THE DRAWINGS

FIG. 1 is a block diagram of a receiver with a signal acquisition search engine, in accordance with an example of the present disclosure.

FIG. 2 is a flow diagram of a signal encryption methodology, in accordance with an example of the present disclosure.

FIG. 3 is a plot of a hop frequency pattern, in accordance with an example of the present disclosure.

FIG. 4 depicts two examples of frequency ranges where the hop frequency pattern of FIG. 3 can lie, in accordance with an example of the present disclosure.

FIG. 5 is a flow diagram of a tone-hopping signal acquisition search process, in accordance with an example of the present disclosure.

FIG. 6 shows a graph representing an incoming signal that has been channelized by the process of FIG. 5, in accordance with an example of the present disclosure.

FIG. 7 is a block diagram of the receiver with the signal acquisition search engine of FIG. 1, in accordance with an example of the present disclosure.

FIG. 8 is a block diagram of the receiver with the signal acquisition search engine of FIG. 1, in accordance with another example of the present disclosure.

FIG. 9 is a plot of the hop frequency pattern of FIG. 3, in accordance with an example of the present disclosure.

FIG. 10 is a block diagram of a processing platform configured to provide a system for three-dimensional tone hopping signal acquisition, in accordance with an example of the present disclosure.

Although the following detailed description refers to illustrative examples, many alternatives, modifications, and variations thereof will be apparent in light of this disclosure.

### DETAILED DESCRIPTION

Techniques are provided herein for three-dimensional tone hopping signal acquisition. A signal acquisition device includes a signal channelizer module configured to channelize an incoming signal into a plurality of channels to produce a channelized signal. In some examples, the signal channelizer module is configured to channelize the incoming signal into a first plurality of channels (e.g., 32 channels or any other number of channels, such as 2ⁿ channels) to produce a first channelized signal, and to further channelize the first plurality of channels into a second plurality of channels (e.g., 64 channels or any other number of channels, such as 2ⁿ channels) to produce a second channelized signal, and to store the second channelized signal into a memory. The signal processing module is configured to retrieve the second channelized signal from the memory and search the second channelized signal for a signal of interest.

In some examples, the first plurality of channels are 32 bandpass channels, and the second plurality of channels are 64 bandpass channels. In some examples, the signal processor is configured to search at least a portion of the second channelized signal across time uncertainty, Doppler uncertainty, and acceleration uncertainty, where the portion of the second channelized signal corresponds to a tone hop. That is, the signal acquisition device need only search a portion of the incoming signal for the signal of interest after the signal has been broken into 2048 channels. In this manner, the disclosed techniques allow rapid time/frequency resolution while searching in highly jammed or otherwise congested environments where time uncertainty is very large and where Doppler and acceleration uncertainty are variable depending on the position of the moving platform relative to the receiver.

### Overview

A receiver first acquires signals from multiple satellites and then computes its geographical position (or other information) based on data encoded in the signals. The signals can, for example, include navigational information (e.g., a time code) or other data uniquely encoded for each satellite and then modulated onto a carrier frequency for transmission, typically with further in-phase and quadrature (IQ) encoding to help the receiver decode the data rapidly, accurately, and reliably. At the receiver, the signals are subject to propagation delay and Doppler frequency shift.

The power of the signals transmitted by the satellites is typically low and therefore the signals are susceptible to noise and jamming. The noise can originate from the satellite transmitter, the receiver, or both. Additional noise may result from multipath propagation, background sources, and other external effects on the transmission. As noted above, the signals are further subject to a Doppler frequency shift that results from the relative motion of the satellite and the receiver. If the noise level and the Doppler frequency shift are relatively high, the time and frequency uncertainty of the signal at the receiver is inherently high, increasing the difficulty of signal detection, discrimination, and acquisition.

For instance, when both the noise level and the Doppler frequency shift are relatively high, such as with low power, low orbit satellites, or while the signal is being jammed, the receiver uses a larger search space to locate the correlation peaks. However, with certain existing signal acquisition techniques, such large search spaces may require a very large brute force search to cover the time and frequency uncertainty. Such a search process is computationally expensive, time consuming, and potentially less precise if certain correlation peaks are not found.

In addition to time uncertainty and Doppler effects on the signal of interest, jamming signals further complicate the signal acquisition process. Signal jamming is an intentional attempt, sometimes hostile, to disrupt the transmission of a signal by injecting another signal that interferes with the signal of interest. In particular, because low Earth orbit satellites have high accelerations relative to the receiver, and because jamming necessitates longer acquisition dwell times, which are inherently limited by the high accelerations, there are enhanced challenges associated with acquiring signals within one or more narrow frequency bands that are spread over a wide frequency range. Therefore, non-trivial issues remain with respect to signal acquisition.

### Receiver with Signal Acquisition Search Engine

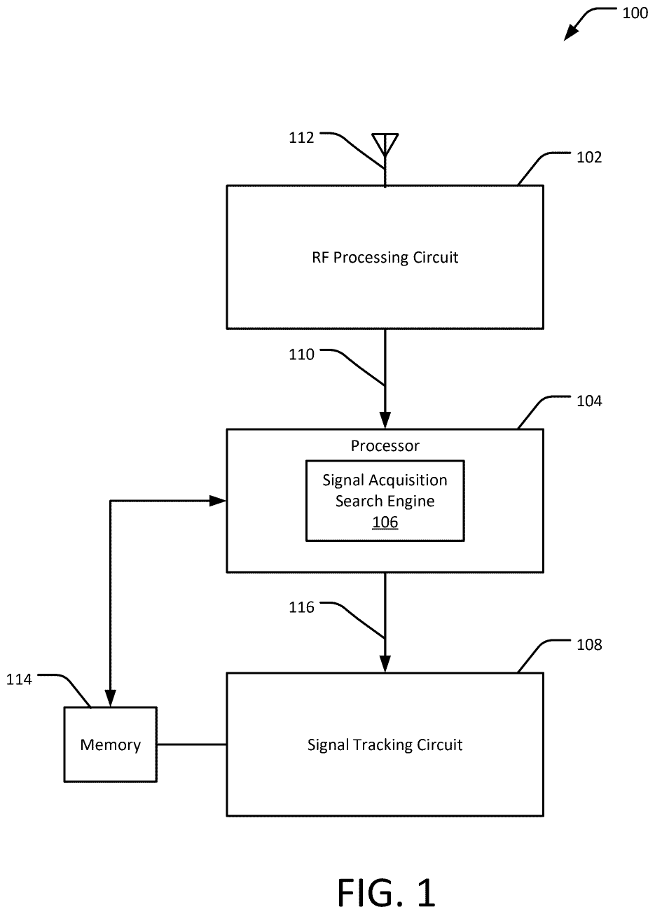

FIG. 1 is a block diagram of a receiver 100 with a signal acquisition search engine, in accordance with an example of the present disclosure. The receiver 100 includes, or is operatively coupled to, an antenna 112. The receiver 100 includes a radio frequency (RF) processing circuit 102, a processor 104, such as an application-specific integrated circuit (ASIC) or a field programmable gate array (FPGA) having a signal acquisition search engine 106, and a signal tracking circuit 108.

The RF processing circuit 102 is configured to provide signals from the antenna 112 to the processor 104. The signals originate from a moving platform, such as a satellite or other space vehicle. For example, the RF processing circuit 102 can include an RF downconverter, an analog-to-digital signal converter/sampler, and a digital signal processor. The RF processing circuit 102 thus converts the RF signals from analog to a sampled digital signal 110 for further processing by the processor 104. The sampled digital signal 110 can be a complex signal, also referred to as an in-phase/quadrature (IQ) signal. The sampled digital signal 110 can, for example, include a code that uniquely identifies a moving platform, such as a space vehicle (e.g., a GPS satellite) transmitting the signals to the receiver 100. It will be understood that the RF processing circuit 102 can be further configured to process other signals received via the antenna 112 from additional space vehicles.

The processor 104 is configured to receive the sampled digital signal 110 and to produce an output signal 116 for further processing by the signal tracking circuit 108. The output signal 116 can include, for example, a magnitude of a peak bin (tone), adjacent bin magnitudes, received signal strengths, and/or a memory pointer into a memory 114 configured to store at least a portion of the sampled digital signal 110. In some examples, the signal acquisition search engine 106, which is integrated into the processor 104, uses a correlation-based computation to detect the presence of a signal with a known or pre-determined form or code within the sampled digital signal 110. Correlation is the process of measuring the similarity between the sampled digital signal 110, which is incoming to the receiver 100, and a set of known signals, also referred to herein as tones and codes. Such correlation detection is useful for acquiring signals in environments where multiple signals are received contemporaneously and where the signals of interest may be obscured by noise and Doppler effects.

In general, the correlation is a value representing the product of the sampled digital signal 110 and one or more generated tones and/or codes summed over an interval. The incoming signal (and thus the sampled digital signal 110) is unknown and may have a very large time uncertainty, in addition to variable Doppler and acceleration uncertainties, due to the motion of the moving platform (e.g., satellite or space vehicle) relative to the receiver 100. The correlation value thus represents the similarity of the sampled digital signal 110 to the tones and codes, where low correlation values (e.g., approaching zero) represent dissimilar signals that are unlikely to be signals of interest for acquisition, and high correlation values represent higher levels of similarity that are more likely to be signals of interest for acquisition.

In some examples, the incoming signal from the moving vehicle is encoded using a frequency-hopping spread spectrum (FHSS) technique. FHSS causes data to be encoded on signals at several different carrier frequencies across a wide band of frequencies. The selection of a given carrier frequency is controlled by a code known to the transmitter (e.g., the moving platform or space vehicle) and the receiver (e.g., the receiver 100). A hopping period defines the amount of time between changes (hops) in the carrier frequency (tone). By rapidly switching (hopping) between different carrier frequencies (tones) according to the code, the signal is less likely to be intercepted or jammed or unlikely to be intercepted or jammed for more than one hopping period. In some examples, the signal is encrypted to further secure the incoming signal from unauthorized access.

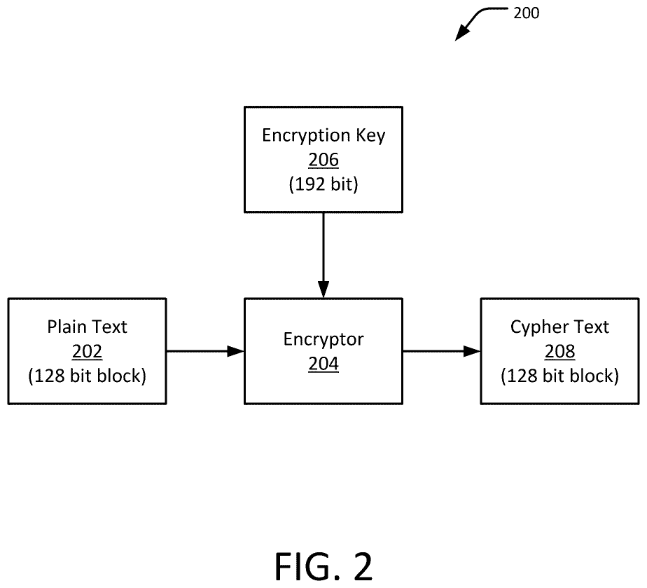

FIG. 2 is a flow diagram of a signal encryption methodology 200, in accordance with an example of the present disclosure. The signal encryption methodology 200 can be implemented, for example, in a transmitter that broadcasts the signal received via the receiver 100 and the antenna 112 of FIG. 1. A plain text message 202 to be transmitted is encrypted by an encryptor 204 using an encryption key 206 to produce cypher text 208. As used in this disclosure, the phrase “cypher text” includes “ciphertext” as will be apparent to one of skill in the art. In some examples, the plain text message 202 includes a 128-bit block of unencrypted data and the cypher text 208 includes a 128-bit block of encrypted data. In some examples, the encryption key is 192 bits.

The cypher text 208 can be transmitted on a square wave signal having a variable frequency, e.g., FHSS. That is, the frequency of the signal is constant during a given hop period and changes to a different frequency during a subsequent hop period. In some examples, the hop frequencies are encoded in the cypher text 208 to secure the hop frequency pattern from unauthorized access.

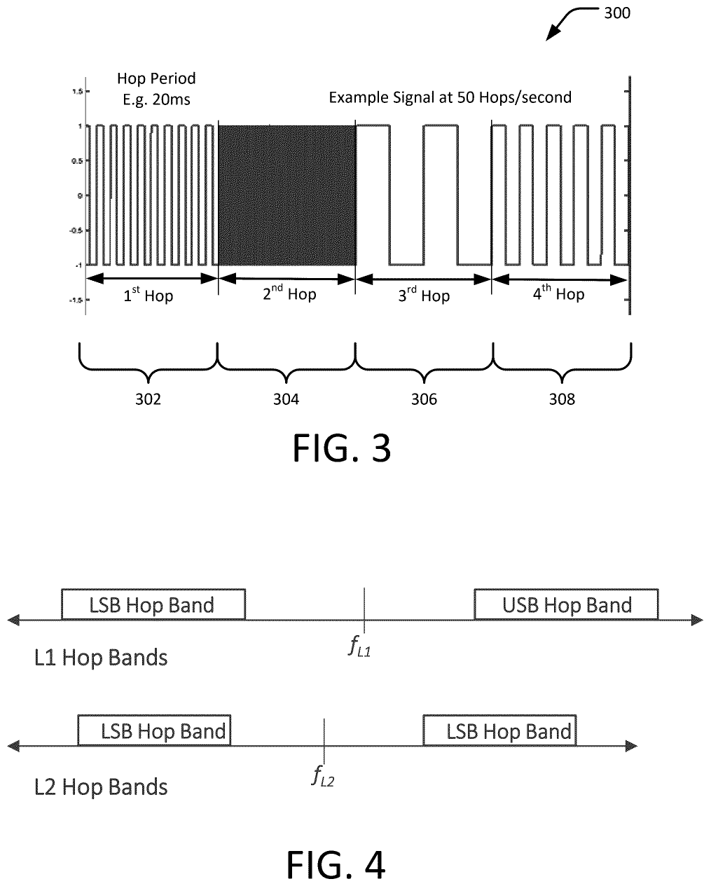

FIG. 3 is a plot of a hop frequency pattern 300 for a signal, such as a signal encrypted using the methodology of FIG. 2, in accordance with an example of the present disclosure. In this example, four hop periods 302, 304, 306, and 308 are shown, where each hop period is 20 milliseconds, with 50 hops/second. The frequency of the signal during each of the hop periods 302, 304, 306, and 308 changes according to the hop frequency pattern in the cypher text 208. In other examples, the signal can be a 20-200 hops/sec square-wave, where the frequency of the square-wave hop changes each hop period. FIG. 4 depicts two examples of frequency ranges where the hop frequency pattern 300 can lie, such as within a lower sideband (LSB) and an upper sideband (USB) of an L1 or L2 GPS signal.

The signal acquisition search engine 106 is configured to search a signal having a given hop frequency pattern for the cypher text 208, such as for the example shown in FIG. 3. The amount of time required to search the signal having an initial time uncertainty (ITU) is a function of the hop rate, where fewer hops reduces the ITU for direct acquisition to +/−one-half of the hop rate uncertainty. Thus, reducing the number of hops to search across time uncertainty also reduces the number of hops to search across Doppler and acceleration uncertainty during the signal acquisition process. The signal acquisition search engine 106 processes data for a given hop and for a one-half bin offset, which yields a frequency resolution of approximately (1/hop rate)/2).

### Signal Acquisition Search

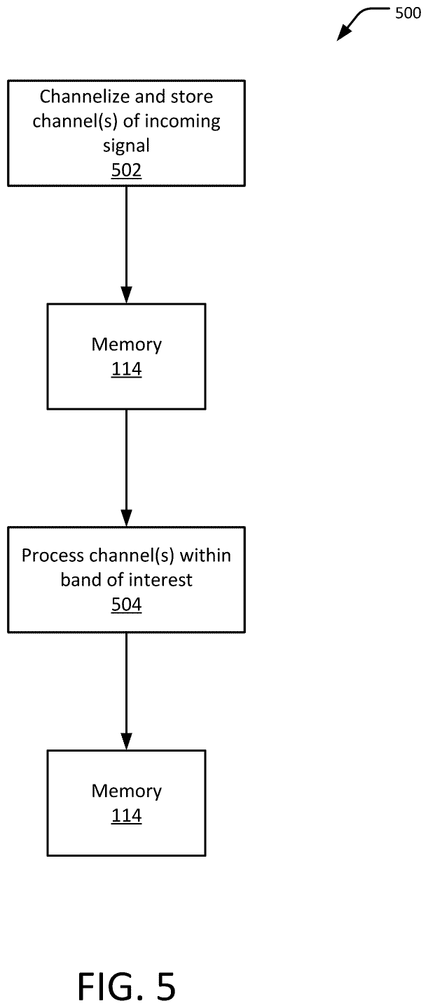

FIG. 5 is a flow diagram of a tone-hopping signal acquisition search process 500, in accordance with an example of the present disclosure. The process 500 can be implemented, for example, in the receiver 100 and/or the processor 104 of FIG. 1. As discussed above, in some examples the process 500 utilizes a store-and-process model, where the channelize and store stage 502 of the signal acquisition search engine 106 channelizes and stores one or more channels of the incoming signal in the memory 114 and subsequently retrieves and processes 504 one or more channels of the incoming signal within a band of interest from the memory 114. The signal acquisition search engine 106 stores the results of the processing 504 in the memory 114, from which the signal tracking circuit 108 can subsequently retrieve and utilize the results.

As discussed in further detail below, the process 500 channelizes the incoming signal into several bandpass, decimated channels and stores the channelized signal data in memory. The process 500 then processes the stored data based on time, Doppler, and acceleration hypotheses. The process 500 is efficient because any number of time (hop) hypotheses, Doppler hypotheses, and acceleration hypotheses can be searched from a single store operation (that is, from the same channelized signal data stored in memory). Only channels or subchannels that have a bearing on the hypotheses are read from memory and further processed, thus the data space for searching the signal is massively reduced. Further, the amount or degree of Doppler and acceleration search space can be traded in exchange for each other and/or for time search space to increase the efficient utilization of the available processing resources, including processors, memory, accumulators, and the like.

### Two-stage Signal Channelization

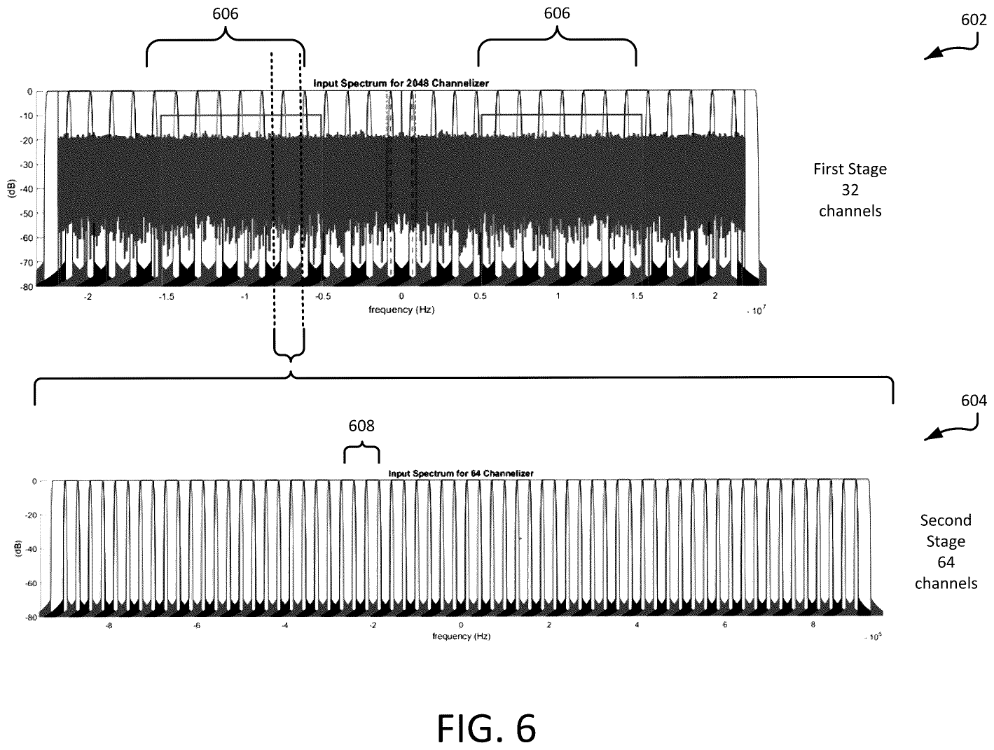

FIG. 6 shows a graph representing an incoming signal that has been channelized by the process 500, in accordance with an example of the present disclosure. In an example, the channelize and store stage 502 channelizes, in a first channelization stage, an incoming signal into 32 channels, a portion of which are indicated at 602 in FIG. 6. The channelize and store stage 502 further channelizes, in a second channelization stage, each of the 32 channels of the incoming signal from the first channelization state into 64 channels, a portion of which are indicated at 604 in FIG. 6. For example, the 64 channels indicated at 604 are channelized from one of the 32 channels indicated at 602.

In some examples, a portion of the channels 602, such as those within a band (or bands) of interest 606, are stored into memory, while the remaining channels are discarded. Thus, only the portion of the channels 602 within the band (or bands) of interest 606 are channelized in the second channelization stage and stored in memory.

From within the signal channels stored in memory after the second channelization stage, the process 500 retrieves at least a portion of the stored signal channels during the processing stage 504. For example, if one hop includes a portion of the incoming signal spanning two of the channels 604 from the second channelization stage, such as indicated at 608 in FIG. 6, then the process 500 retrieves and processes those two channels or portions of those two channels corresponding to one or more hops.

### Channelize-and-Store Processing

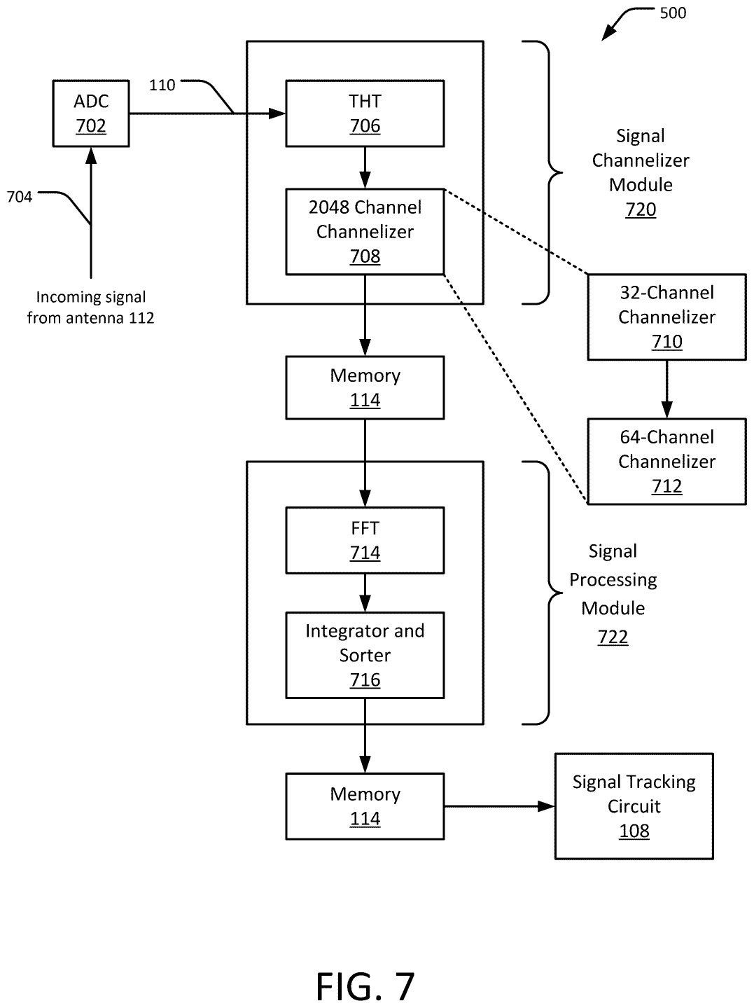

FIG. 7 is a block diagram of a receiver with the signal acquisition search engine 106 of FIG. 1 implementing the process 500 of FIG. 5 in further detail, in accordance with an example of the present disclosure. An analog-to-digital converter (ADC) 702, which can, for example, be included in the RF processing circuit 102 of FIG. 3, or other signal processing circuit converts an incoming signal 704 into the sampled digital signal 110.

In an example, the channelize and store stage 502 is implemented in a signal channelizer module 720 of the RF processing circuit 102. The signal channelizer module 720 includes a Tunable Hilbert Transformer (THT) 706 followed by a 2048-channel channelizer 708. The THT 706 obtains the minimum-phase response from a spectral analysis of the incoming signal. When performing a conventional FFT, any signal energy occurring after time t=0 will produce a linear delay component in the phase of the FFT. Even if a pulse occurs at t=0, if the pulse has finite width, it will produce a linear slope in the resulting FFT phase. The slope of the FFT phase (versus frequency) is proportional to this time delay term. Significant delays can produce phase variations of greater than 2π. If the FFT data contains phase nonlinearities of interest (such as a small bump), they can be hidden by this large linear phase component. Thus, the THT 706, which unlike the FFT is not constrained by assumptions of linearity in the signal, will produce a frequency response with the linear-phase component removed. This is the “minimum phase” data desired. The THT 706 involves signal processing in both the time and frequency domains.

The 2048-channel channelizer includes, for example, a 32-channel channelizer 710 (first stage channelizer) in series with a 64-channel channelizer 712 (second stage channelizer). The 32-channel channelizer 710 channelizes the sampled digital signal 110 representing the incoming signal into 32 channels 602 across a first range of frequencies, and the 64-channel channelizer 712 channelizes each of the 32 channels 602 into 64 channels across a second range of frequencies, for a total of 2048 channels of signal data. The two-stage channelizer (as opposed to a single stage channelizer) conserves memory by breaking the incoming signal 704 into multiple low-rate bandpass channels and storing the entire dwell into memory 114 before the process channels stage 504 reads back and operates on the data from memory 114. Only channels within the band of interest are stored in the memory; the remainder are discarded.

The process channels stage 504 is implemented in a signal processing module 722 of the RF processing circuit 102. The signal processing module 722 includes a Fast Fourier Transform (FFT) processor 714 and an integrator and sorter 716, which are used to search for and acquire the signal of interest from the incoming signal 704. The signal acquisition search engine 106 is configured to search the channelized signals stored in the memory 114 across three dimensions: time, Doppler, and acceleration uncertainties. In particular, the signal acquisition search engine 106 is configured to facilitate dwell times that are long enough to detect a signal of interest under high jamming conditions. The signal acquisition search engine 106 incorporates the store-and-process model, such as described with respect to FIGS. 5-7 including the two-stage, 2048-channel channelizer 708 (e.g., 32 channels in the first stand and 64 channels in the second stage), which divides the incoming signal 704 into multiple low rate bandpass channels and stores the channels into memory 114, followed by a process stage, which reads back the data from memory 114 and searches the data for a signal of interest. In some examples, the process stage searches across a hop frequency plus-and-minus the Doppler and acceleration hypothesis, and does not search the entire signal spectrum. The data for a particular hop is run through the FFT processor 714, which includes a one-half bin offset FFT and yields a frequency granularity of approximately one-half of (1/(hop rate)).

For example, the process channels stage 504 of the signal acquisition search engine 106 calculates two FFT streams, each shifted by one-half of the hop period, providing a time resolution of no less than one-quarter of a hop. The process channels stage 504 only needs to receive and search the hop frequency plus-and-minus the Doppler and acceleration hypothesis of the signal to search, not the entire signal spectrum. Two FFT streams are calculated, each shifted by ½ hop period, because the receiver does not know the hop timing. This means that the time resolution is, at worst, off by no more than ¼ of a hop. The signal acquisition search engine 106 maintains separate accumulators for each Doppler/acceleration hypothesis, which are root sum squared combined for the entire dwell, for a given hop hypothesis. Once the search is complete for a given hop hypothesis, the signal acquisition search engine 106 runs the accumulations through the integrator and sorter 716 to determine if any results (e.g., signal magnitudes) are above a threshold value, and to select and store into memory 114 the largest and/or earliest of those results as potential signals of interest for further processing by the signal tracking circuit 108. In some examples, the integrator and sorter 716 estimates the magnitudes using half sums (or partial sums) for at least portions (e.g., the high, mid, and/or low portions) of the signal.

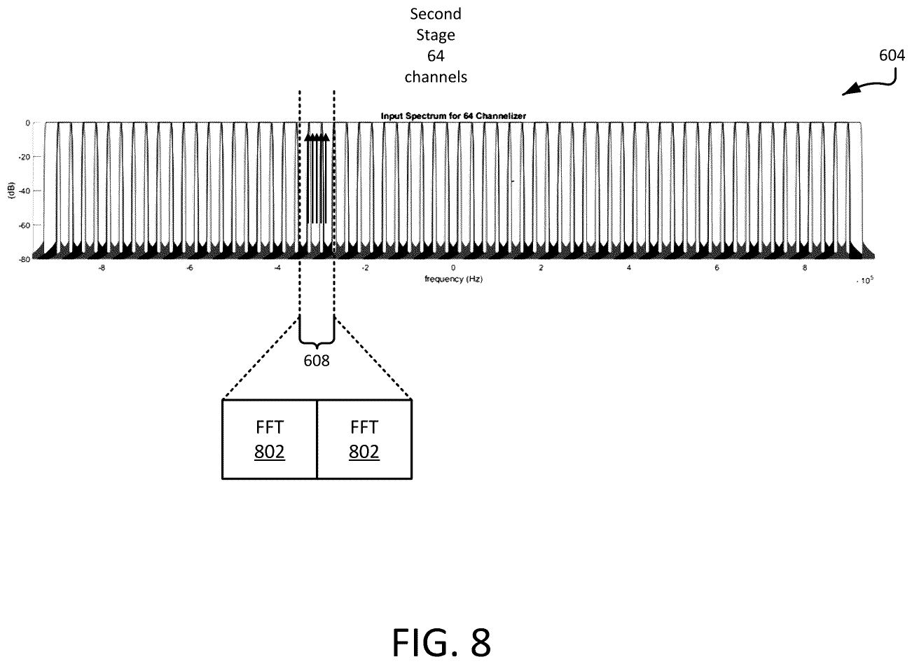

FIG. 8 shows a graph of the channels 604 from the second stage (64-channel) channelizer 712 of FIG. 7, in accordance with an example of the present disclosure. As noted above, each hop includes a portion of the incoming signal 704 spanning two or more (k) of the channels 604 from the second channelization stage 608. Each hop is processed (e.g., during a Doppler search) by the FFT processor 714 to produce an FFT 802, which includes an FFT (unshifted) followed by a ½ bin shifted FFT 804 to reduce 3 dB of scalloping loss to 1 dB. A normal FFT bin overlap has bins overlapping at the −3 dB point. A ½ bin spacing has bins overlapping at the −0.9 dB point, providing a ˜2 dB improvement. Each operation of the channelize and store stage 502 covers the dwell time and time uncertainty of the incoming signal 704. Therefore, the signal acquisition search engine 106 can continue to search as much time uncertainty, Doppler, and acceleration uncertainty as desired or needed from the channels 604. The FFT processor 714 produces an FFT 902 (unshifted) followed by a ½ bin shifted FFT 804 to reduce 3 dB of scalloping loss to 1 dB. Each FFT 802 is computed for only those channels where Doppler/acceleration spread and acceleration spread are to be searched. Each FFT 802 occurs over ½ hop in time. A magnitude is then calculated for each ½ hop. Multiple ½ hops are combined over entire dwell, as well as lower and upper sidebands. Separate accumulators are used for each Doppler/acceleration hypothesis over the dwell. Acceleration causes tone hypotheses spread to increase as the search progresses through the dwell. Integrating acceleration adds Doppler to the result.

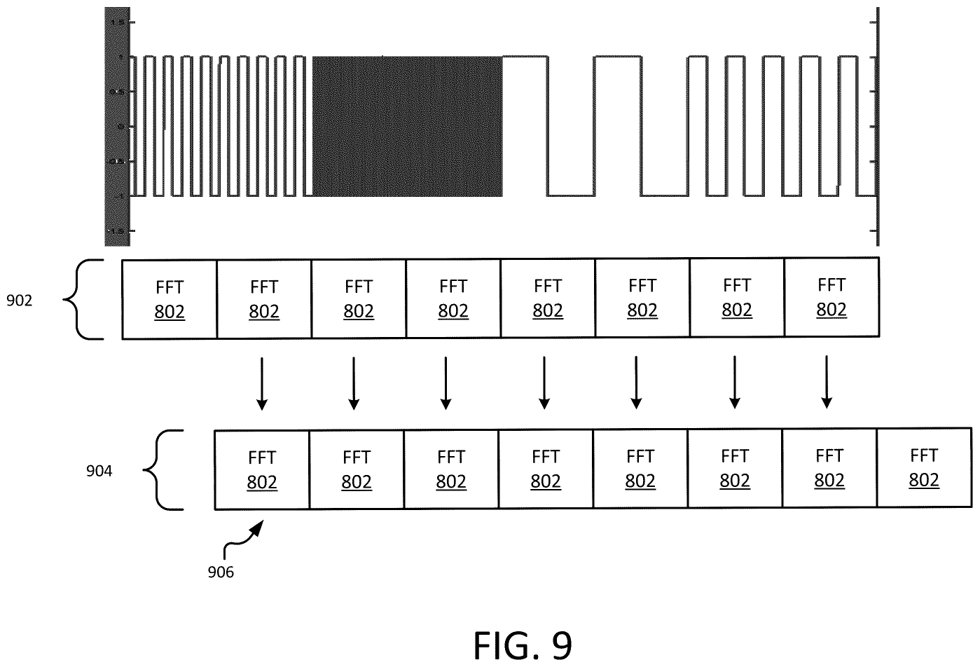

FIG. 9 is the plot of the hop frequency pattern 300 of FIG. 3 with corresponding FFTs for each hop, in accordance with an example of the present disclosure. As noted above, each FFT 802 occurs over ½ hop in time, and the magnitude is calculated for each ½ hop. A first stream 902 of FFTs is shown in FIG. 9. Each FFT 802 (for each hop) is stored in a separate accumulator (e.g., one or more accumulators for each FFT). A second stream 904 occurs on the first (random) hop timing, and a second ½ hop delayed. This guarantees a worst case hop timing of ¼ hop. Because the first FFT 802 (indicated at 906) of the second stream 904 (the ½ hop delayed stream) has already been calculated for the first stream 902, it does not need to be recalculated and can be reused in the second stream 904.

### Hardware Resource Allocation

For a given number of accumulators, tradeoffs can occur between time, Doppler, and acceleration hypothesis. For example, increasing the number of accumulators used for Doppler reduces the number of accumulators used for time and/or acceleration, and likewise decreasing the number of accumulators used for Doppler increases the number of accumulators used for time and/or acceleration. In some examples, such changes in the use of accumulators can be made dynamically or on a predictive basis for a given set of signal conditions. For example, the worst case for Doppler/acceleration hypotheses is when the satellite is directly overhead of the receiver. In such a situation, more accumulators can be used for Doppler/acceleration hypothesis than for time. The physics of the satellite motion generally means that when Doppler is at a maximum (e.g., under a first set of signal conditions), acceleration is low, and when acceleration is high, Doppler is lower (under a second set of signal conditions). Depending on the trajectory of the satellite, tradeoffs between Doppler search and time/acceleration search can thus be made to improve the signal search and acquisition speed and performance.

The disclosed techniques are useful for providing a wide Doppler/acceleration search capability in high dynamic environments. For instance, the disclosed techniques permit time resolution for performing a direct M Code acquisition. The disclosed techniques allow rapid time/frequency resolution in highly jammed or otherwise congested environments where time uncertainty is very large. The disclosed techniques can be used in Global Positioning System (GPS) and non-GPS frequency bands.

### Example Processing Platform

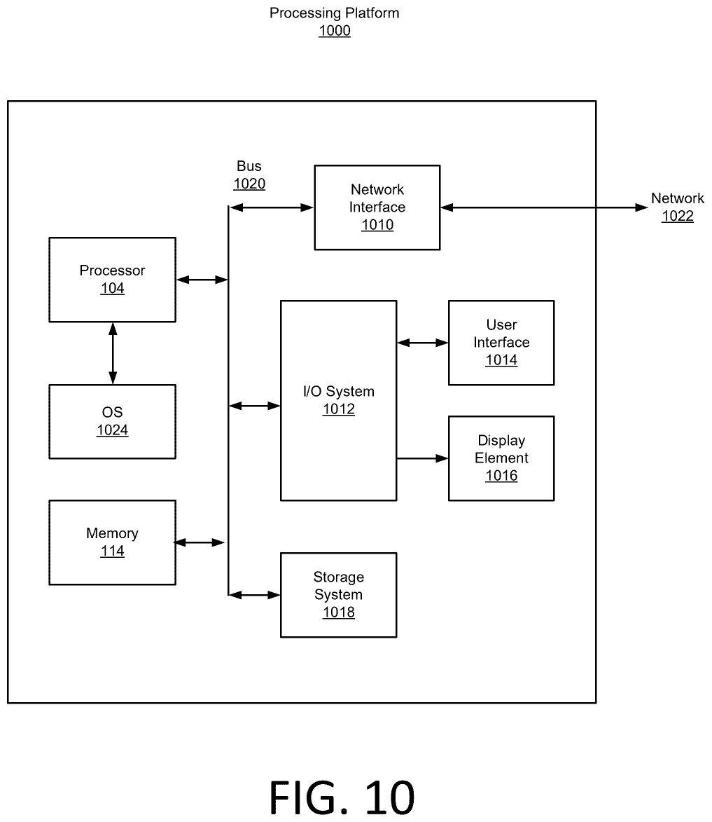

FIG. 10 is a block diagram of a platform 1000 configured to provide a system for three-dimensional tone hopping signal acquisition, in accordance with an example of the present disclosure. In some examples, the platform 1000, or portions thereof, can be hosted on, or otherwise be incorporated into the electronic systems of a satellite receiver, including data communications systems, radar systems, computing systems, or embedded systems of any kind. The disclosed techniques can also be used to improve the reliability of satellite signal acquisition in other platforms including data communication devices, personal computers, workstations, laptop computers, tablets, touchpads, portable computers, handheld computers, cellular telephones, smartphones, or messaging devices.

In an example, the platform 1000 includes any combination of the processor 104, the memory 114, a network interface 1010, an input/output (I/O) system 1012, a user interface 1014, a display element 1016, and a storage system 1018. For example, the platform includes the receiver 100 of FIG. 1, including the memory 114 and the processor 104 with the signal acquisition search engine 106 of FIG. 3. A bus and/or interconnect 1020 is provided to allow for communication between the various components listed above and/or other components of the platform 1000. The platform 1000 can be coupled to a network 1022 through the network interface 1010 to allow for communications with other computing devices, platforms, devices to be controlled, and/or other resources. Other componentry and functionality not reflected in FIG. 10 will be apparent in light of this disclosure, and it will be appreciated that other examples are not limited to any particular hardware configuration.

The processor 104 can be any suitable processor, and can include one or more coprocessors or controllers, such as an audio processor, a graphics processing unit, or hardware accelerator, to assist in the execution of mission software and/or any control and processing operations associated with the platform 1000. In some examples, the processor 104 is implemented as one or more processor cores. The processor core or cores can include any type of processor, such as, for example, a micro-processor, an embedded processor, a digital signal processor (DSP), a graphics processor (GPU), a network processor, a field programmable gate array (FPGA), or other computing or electronic device. The processor 104 can have multithreaded cores such that the processor 104 includes more than one hardware thread context or logical processor per core. In some examples, the processor 104 can be implemented as a complex instruction set computer (CISC) or a reduced instruction set computer (RISC) processor.

The memory 114 can be implemented using any suitable type of digital storage including, for example, a random-access memory (RAM). A random-access memory is any memory having storage locations, or cells, which can be read from and written to in any order. For example, the memory 114 can be implemented as a volatile memory device such as a RAM, dynamic RAM (DRAM), or static RAM (SRAM) device. The storage system 1018 can be implemented as a non-volatile storage device such as a hard disk drive (HDD), a solid-state drive (SSD), a universal serial bus (USB) drive, an optical disk drive, tape drive, an internal storage device, an attached storage device, flash memory, battery backed-up synchronous DRAM (SDRAM), and/or a network accessible storage device.

In some examples, the processor 104 can be configured to execute an Operating System (OS) 1024, which can, for example, include any suitable operating system, such as Google Android (Google Inc., Mountain View, CA), Microsoft Windows (Microsoft Corp., Redmond, WA), macOS (Apple Inc., Cupertino, CA), Linux, or a real-time operating system (RTOS). In some examples, the processor 104 is a special purpose device configured to perform one or more of the functions variously described herein.

The network interface 1010 can be any network chip or chipset that provides wired and/or wireless connection between other components of the platform 1000 and/or the network 1022, thereby enabling the platform 1000 to communicate with other local and/or remote computing systems, and/or other resources. Wired communication can include, for example, Ethernet. Wireless communication can include cellular communications including LTE (Long Term Evolution) and 5G, Wireless Fidelity (Wi-Fi), Bluetooth, and/or Near Field Communication (NFC). Wireless networks can include, for example, wireless local area networks, wireless personal area networks, wireless metropolitan area networks, cellular networks, and satellite networks.

The I/O system 1012 can be configured to interface between various I/O devices and other components of platform 1000. I/O devices can include, for example, the user interface 1014 and the display element 1016. The user interface 1014 can include input/output devices such as a touchpad, keyboard, and mouse, etc., for example, to allow the user to interact with the platform 1000 or components of the platform 1000. The display element 1016 can, for example, be configured to display information to a user. The I/O system 1012 can include a graphics component configured render graphics on the display element 1016. The graphics component can include, for example, a graphics processing unit or a visual processing unit. An analog or digital interface can be used to communicatively couple graphics subsystem and the display element. For example, the interface can include a high definition multimedia interface (HDMI), DisplayPort, wireless HDMI, and/or any other suitable interface using wireless high definition compliant techniques. In some examples, the graphics subsystem can be integrated into the processor 104 or another component (e.g., a graphics chipset) of the platform 1000.

It will be appreciated that in some examples, the various components of the platform 1000 can be combined or integrated in a system-on-a-chip (SoC) architecture. In some examples, the components can be hardware components, firmware components, software components or any suitable combination of hardware, firmware, or software.

In some examples, the platform 1000 can be implemented as a wireless system, a wired system, or a combination of both. When implemented as a wireless system, the platform 1000 can include components and interfaces suitable for communicating over a wireless shared media, such as one or more antennae, transmitters, receivers, transceivers, amplifiers, filters, control logic, and so forth. An example of wireless shared media can include portions of a wireless spectrum, such as the radio frequency spectrum and so forth. When implemented as a wired system, the platform 1000 can include components and interfaces suitable for communicating over wired communications media, such as input/output adapters, physical connectors to connect the input/output adaptor with a corresponding wired communications medium, a network interface card (NIC), disc controller, video controller, audio controller, and so forth. Examples of wired communications media can include a wire, cable metal leads, printed circuit board (PCB), backplane, switch fabric, semiconductor material, twisted pair wire, coaxial cable, fiber optics, and so forth.

Various examples of the present disclosure can be implemented using hardware elements, software elements, or a combination of both. Examples of hardware elements can include processors, microprocessors, circuits, circuit elements (for example, transistors, resistors, capacitors, inductors, and so forth), integrated circuits, ASICs, programmable logic devices, digital signal processors, FPGAs, logic gates, registers, semiconductor devices, chips, microchips, chipsets, and so forth. Examples of software can include software components, programs, applications, computer programs, application programs, system programs, machine programs, operating system software, middleware, firmware, software modules, routines, subroutines, functions, methods, procedures, software interfaces, application program interfaces, instruction sets, computing code, computer code, code segments, computer code segments, words, values, symbols, or any combination thereof. Determining whether an embodiment is implemented using hardware elements and/or software elements can vary in accordance with any number of factors, such as desired computational rate, power level, heat tolerances, processing cycle budget, input data rates, output data rates, memory resources, data bus speeds, and other design or performance constraints.

Some embodiments can be described using the expression “coupled” and “connected” along with their derivatives. These terms are not intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still cooperate or interact with each other.

Some examples disclosed herein can be implemented in various forms of hardware, software, firmware, and/or special purpose processors. For example, in one example, at least one non-transitory computer readable storage medium has instructions encoded thereon that, when executed by one or more processors, cause one or more of the methodologies disclosed herein to be implemented. The instructions can be encoded using a suitable programming language, such as C, C++, object oriented C, Java, JavaScript, Visual Basic.NET, Beginner's All-Purpose Symbolic Instruction Code (BASIC), or alternatively, using custom or proprietary instruction sets. The instructions can be provided in the form of one or more computer software applications and/or applets that are tangibly embodied on a memory device, and that can be executed by a computer having any suitable architecture. In one example, the system can be hosted on a given website and implemented, for example, using JavaScript or another suitable browser-based technology. For instance, in some examples, the platform 1000 can leverage processing resources provided by a remote computer system accessible via the network 1022. The computer software applications disclosed herein can include any number of different modules, sub-modules, or other components of distinct functionality, and can provide information to, or receive information from, still other components. These modules can be used, for example, to communicate with input and/or output devices such as a display screen, a touch sensitive surface, a printer, and/or any other suitable device. Other componentry and functionality not reflected in the illustrations will be apparent in light of this disclosure, and it will be appreciated that other examples are not limited to any particular hardware or software configuration. Thus, in some examples, the platform 1000 can include additional, fewer, or alternative subcomponents as those described above.

The non-transitory computer readable medium can include any suitable medium for storing digital information, such as a hard drive, a server, a flash memory, and/or random-access memory (RAM), or a combination of memories. In some examples, the components and/or modules disclosed herein can be implemented with hardware, including gate level logic such as a field-programmable gate array (FPGA), or alternatively, a purpose-built semiconductor such as an application-specific integrated circuit (ASIC). Still other examples can be implemented with a microcontroller having a number of input/output ports for receiving and outputting data, and a number of embedded routines for carrying out the various functionalities disclosed herein. It will be apparent that any suitable combination of hardware, software, and firmware can be used, and that other examples are not limited to any particular system architecture.

Some examples can be implemented, for example, using a machine readable medium or article that stores a set of instructions that, when executed by a machine, causes the machine to perform a method, process, and/or operations in accordance with the examples described herein. Such a machine can include, for example, any suitable processing platform, computing platform, computing device, processing device, computing system, processing system, computer, process, or the like, and can be implemented using any suitable combination of hardware and/or software. The machine readable medium or article can include, for example, any suitable type of memory unit, memory device, memory article, memory medium, storage device, storage article, storage medium, and/or storage unit, such as memory, removable or non-removable media, erasable or non-erasable media, writeable or rewriteable media, digital or analog media, hard disk, floppy disk, compact disk read only memory (CD-ROM), compact disk recordable (CD-R) memory, compact disk rewriteable (CD-RW) memory, optical disk, magnetic media, magneto-optical media, removable memory cards or disks, various types of digital versatile disk (DVD), a tape, a cassette, or the like. The instructions can include any suitable type of code, such as source code, compiled code, interpreted code, executable code, static code, dynamic code, encrypted code, and the like, implemented using any suitable high level, low level, object oriented, visual, compiled, and/or interpreted programming language.

Unless specifically stated otherwise, it will be appreciated that terms such as “processing,” “computing,” “calculating,” and “determining” refer to the action and/or process of a computer or computing system, or similar electronic computing device, that manipulates and/or transforms data represented as physical quantities (for example, electronic) within the registers and/or memory units of the computer system into other data similarly represented as physical entities within the registers, memory units, or other such information storage transmission or displays of the computer system.

The terms “circuit” or “circuitry” can include, for example, hardwired circuitry, programmable circuitry, such as computer processors comprising one or more individual instruction processing cores, state machine circuitry, and/or firmware that stores instructions executed by programmable circuitry. The circuitry can include a processor and/or controller configured to execute one or more instructions to perform one or more operations described herein. The instructions can be implemented as, for example, an application, software, firmware, etc., configured to cause the circuit or circuitry to perform any of the operations or functions described herein. Software can be implemented as a software package, code, instructions, instruction sets and/or data recorded on a computer-readable storage device. Software can be implemented to include any number of processes, and processes, in turn, can be implemented to include any number of threads, etc., in a hierarchical fashion. Firmware can be implemented as code, instructions or instruction sets and/or data that are hard-coded (e.g., nonvolatile) in memory devices. The circuit or circuitry can be implemented as part of a larger system, for example, an integrated circuit (IC), an application-specific integrated circuit (ASIC), a system-on-a-chip (SoC), desktop computers, laptop computers, tablet computers, servers, smartphones, etc. Other examples can be implemented as software executed by a programmable control device. In such cases, the terms “circuit” or “circuitry” are intended to include a combination of software and hardware such as a programmable control device or a processor capable of executing the software. As described herein, various examples can be implemented using hardware elements, software elements, or any combination thereof.

Examples of hardware elements can include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, and/or chip sets.

### Further Example Examples

The following examples pertain to further examples, from which numerous permutations and configurations will be apparent.

Example 1 provides a signal acquisition device comprising a signal channelizer module configured to channelize an incoming signal from a moving platform into a first plurality of channels across a first range of frequencies to produce a first channelized signal; channelize the first channelized signal into a second plurality of channels across a second range of frequencies to produce a second channelized signal; and store the second channelized signal into a memory; and a signal processing module configured to retrieve the second channelized signal from the memory; and search the second channelized signal for a signal of interest.

Example 2 includes the subject matter of Example 1, wherein the first plurality of channels are 2ⁿ bandpass channels, and wherein the second plurality of channels are 2ⁿ bandpass channels.

Example 3 includes the subject matter of any one of Examples 1 and 2, wherein the signal processor is configured to search at least a portion of the second channelized signal across time uncertainty, Doppler uncertainty, and acceleration uncertainty, and wherein the portion of the second channelized signal corresponds to a tone hop.

Example 4 includes the subject matter of Example 3, wherein the signal processor is configured to apply a Fast Fourier Transform to the second channelized signal.

Example 5 includes the subject matter of any one of Examples 3 and 4, wherein the signal processor is configured to apply a Fast Fourier Transform to a one-half bin offset of the second channelized signal.

Example 6 includes the subject matter of any one of Examples 3-5, wherein the portion of the second channelized signal searched across acceleration uncertainty is stored in a first set of accumulators and the portion of the second channelized signal searched across Doppler uncertainty is stored in a second set of accumulators.

Example 7 includes the subject matter of Example 6, wherein the first set of accumulators is greater than the second set of accumulators under a first set of signal conditions, wherein the first set of accumulators is less than the second set of accumulators under a second set of signal conditions.

Example 8 includes the subject matter of Example 7, wherein under the first set of signal conditions acceleration of the moving platform is lower than Doppler, and wherein under the second set of signal conditions acceleration of the moving platform is higher than Doppler.

Example 9 includes the subject matter of any one of Examples 1-8, wherein the signal channelizer module includes a Tunable Hilbert Transformer configured to obtain a minimum-phase response of the incoming signal.

Example 10 provides a signal acquisition device comprising a signal channelizer module configured to channelize an incoming signal from a moving platform into a plurality of channels; and a signal processing module configured to search at least a portion of the plurality channels for a signal of interest across time uncertainty, Doppler uncertainty, and acceleration uncertainty, wherein the portion of the plurality of channels includes a tone hop.

Example 11 includes the subject matter of Example 10, wherein signal channelizer module includes a first stage channelizer in series with a second stage channelizer.

Example 12 includes the subject matter of Example 11, wherein the first stage channelizer is a 32-channel channelizer and the second stage channelizer is a 64-channel channelizer.

Example 13 includes the subject matter of any one of Examples 10-12, wherein the signal channelizer module includes a Tunable Hilbert Transformer configured to obtain a minimum-phase response of the incoming signal.

Example 14 includes the subject matter of any one of Examples 10-13, further comprising a first set of accumulators and a second set of accumulators, wherein the portion of the plurality of channels searched across acceleration uncertainty is stored in the first set of accumulators and the portion of the plurality of channels searched across Doppler uncertainty is stored in the second set of accumulators.

Example 15 includes the subject matter of Example 14, wherein the first set of accumulators is greater than the second set of accumulators under a first set of signal conditions, wherein the first set of accumulators is less than the second set of accumulators under a second set of signal conditions.

Example 16 includes the subject matter of Example 15, wherein under the first set of signal conditions acceleration of the moving platform is lower than Doppler, and wherein under the second set of signal conditions acceleration of the moving platform is higher than Doppler.

Example 17 provides a method for signal acquisition, the method comprising channelizing an incoming signal from a moving platform into a first plurality of channels across a first range of frequencies to produce a first channelized signal; channelizing the first channelized signal into a second plurality of channels across a second range of frequencies to produce a second channelized signal; retrieving the second channelized signal from the memory; and searching the second channelized signal for a signal of interest.

Example 18 includes the subject matter of Example 17, wherein the first plurality of channels are 32 bandpass channels, and wherein the second plurality of channels are 64 bandpass channels.

Example 19 includes the subject matter of any one of Examples 17 and 18, wherein at least a portion of the second channelized signal is searched across time uncertainty, Doppler uncertainty, and acceleration uncertainty, and wherein the portion of the second channelized signal corresponds to a tone hop.

Example 20 includes the subject matter of Example 19, wherein the portion of the second channelized signal searched across acceleration uncertainty is stored in a first set of accumulators and the portion of the second channelized signal searched across Doppler uncertainty is stored in a second set of accumulators, wherein the first set of accumulators is greater than the second set of accumulators under a first set of signal conditions, wherein the first set of accumulators is less than the second set of accumulators under a second set of signal conditions, wherein under the first set of signal conditions acceleration of the moving platform is lower than Doppler, and wherein under the second set of signal conditions acceleration of the moving platform is higher than Doppler.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

What is claimed is:

1. A signal acquisition device comprising:
a signal channelizer module configured to
channelize an incoming signal from a moving platform into a first plurality of channels across a first range of frequencies to produce a first channelized signal;
channelize the first channelized signal into a second plurality of channels across a second range of frequencies to produce a second channelized signal; and
store the second channelized signal into a memory; and
a signal processing module configured to
retrieve the second channelized signal from the memory; and
search the second channelized signal for a signal of interest.

2. The signal acquisition device of claim 1, wherein the first plurality of channels are 32 bandpass channels, and wherein the second plurality of channels are 64 bandpass channels.

3. The signal acquisition device of claim 1, wherein the signal processor is configured to search at least a portion of the second channelized signal across time uncertainty, Doppler uncertainty, and acceleration uncertainty, and wherein the portion of the second channelized signal corresponds to a tone hop.

4. The signal acquisition device of claim 3, wherein the signal processor is configured to apply a Fast Fourier Transform to the second channelized signal.

5. The signal acquisition device of claim 3, wherein the signal processor is configured to apply a Fast Fourier Transform to a one-half bin offset of the second channelized signal.

6. The signal acquisition device of claim 3, wherein the portion of the second channelized signal searched across acceleration uncertainty is stored in a first set of accumulators and the portion of the second channelized signal searched across Doppler uncertainty is stored in a second set of accumulators.

7. The signal acquisition device of claim 6, wherein the first set of accumulators is greater than the second set of accumulators under a first set of signal conditions, wherein the first set of accumulators is less than the second set of accumulators under a second set of signal conditions.

8. The signal acquisition device of claim 7, wherein under the first set of signal conditions acceleration of the moving platform is lower than Doppler, and wherein under the second set of signal conditions acceleration of the moving platform is higher than Doppler.

9. The signal acquisition device of claim 1, wherein the signal channelizer module includes a Tunable Hilbert Transformer configured to obtain a minimum-phase response of the incoming signal.

10. A signal acquisition device comprising:
a signal channelizer module configured to channelize an incoming signal from a moving platform into a plurality of channels; and
a signal processing module configured to search at least a portion of the plurality channels for a signal of interest across time uncertainty, Doppler uncertainty, and acceleration uncertainty, wherein the portion of the plurality of channels includes a tone hop.

11. The signal acquisition device of claim 10, wherein signal channelizer module includes a first stage channelizer in series with a second stage channelizer.

12. The signal acquisition device of claim 11, wherein the first stage channelizer is a 32-channel channelizer and the second stage channelizer is a 64-channel channelizer.

13. The signal acquisition device of claim 10, wherein the signal channelizer module includes a Tunable Hilbert Transformer configured to obtain a minimum-phase response of the incoming signal.

14. The signal acquisition device of claim 10, further comprising a first set of accumulators and a second set of accumulators, wherein the portion of the plurality of channels searched across acceleration uncertainty is stored in the first set of accumulators and the portion of the plurality of channels searched across Doppler uncertainty is stored in the second set of accumulators.

15. The signal acquisition device of claim 14, wherein the first set of accumulators is greater than the second set of accumulators under a first set of signal conditions, wherein the first set of accumulators is less than the second set of accumulators under a second set of signal conditions.

16. The signal acquisition device of claim 15, wherein under the first set of signal conditions acceleration of the moving platform is lower than Doppler, and wherein under the second set of signal conditions acceleration of the moving platform is higher than Doppler.

17. A method for signal acquisition, the method comprising:
channelizing an incoming signal from a moving platform into a first plurality of channels across a first range of frequencies to produce a first channelized signal;
channelizing the first channelized signal into a second plurality of channels across a second range of frequencies to produce a second channelized signal;
retrieving the second channelized signal from the memory; and
searching the second channelized signal for a signal of interest.

18. The method of claim 17, wherein the first plurality of channels are 32 bandpass channels, and wherein the second plurality of channels are 64 bandpass channels.

19. The method of claim 17, wherein at least a portion of the second channelized signal is searched across time uncertainty, Doppler uncertainty, and acceleration uncertainty, and wherein the portion of the second channelized signal corresponds to a tone hop.

20. The method of claim 19, wherein the portion of the second channelized signal searched across acceleration uncertainty is stored in a first set of accumulators and the portion of the second channelized signal searched across Doppler uncertainty is stored in a second set of accumulators, wherein the first set of accumulators is greater than the second set of accumulators under a first set of signal conditions, wherein the first set of accumulators is less than the second set of accumulators under a second set of signal conditions, wherein under the first set of signal conditions acceleration of the moving platform is lower than Doppler, and wherein under the second set of signal conditions acceleration of the moving platform is higher than Doppler.
